(19) United States
(12) Patent Application Publication
(10) Pub. No.: US 2020/0142719 A1
(43) Pub. Date: May 7, 2020

(54) AUTOMATIC GENERATION OF CHATBOT META COMMUNICATION

(71) Applicant: INTERNATIONAL BUSINESS MACHINES CORPORATION, ARMONK, NY (US)

(72) Inventors: Muhtar Burak Akbulut, Waban, MA (US); Donna K. Byron, Petersham, MA (US); Dan O'Connor, Milton, MA (US)

(21) Appl. No.: 16/179,289

(22) Filed: Nov. 2, 2018

(51) Int. Cl. G06F 9/451

(52) U.S. Cl. CPC G06F 9/453

(57) ABSTRACT

A system configured to provide dynamic help support in a chatbot application. The system includes memory for storing instructions, and a processor configured to execute the instructions to create a chatbot application using a chatbot development platform, wherein the chatbot application implements a dynamic user-support capability of the chatbot development platform; determine that a user of the chatbot application requires user assistance in interacting with the chatbot application; and provide the user with intent-examples using the dynamic user-support capability of the chatbot development platform.

### BACKGROUND

Conversational systems, also known as conversational agents, bots, or chatbots are becoming ubiquitous. A chatbot is a computer program which conducts a conversation via auditory or textual methods. Chatbots typically employ natural language understanding (NLU), artificial intelligence and dialog techniques to interact with users and have various practical purposes including customer service or customer support.

### SUMMARY

In one aspect, the disclosed embodiments include a system, computer program product, and computer-implemented method for providing dynamic user assistance in a chatbot application. In one embodiment, the computer-implemented method creates a chatbot application that implements a dynamic user-support capability of a chatbot development platform. The computer-implemented method determines that a user of the chatbot application requires user assistance in interacting with the chatbot application. The computer-implemented method provides the user with dynamically generated help content based on the most likely intents, entities and dialog flows using the dynamic user-support capability of the chatbot development platform. Dynamic help content is calculated based on many features, including conversation-designer's dialog flow, training examples, and statistics on chat logs.

Another embodiment is a system configured to provide dynamic help support in a chatbot application. The system includes memory for storing instructions, and a processor configured to execute the instructions to create a chatbot application using a chatbot development platform, wherein the chatbot application implements a dynamic user-support capability of the chatbot development platform; determine that a user of the chatbot application requires user assistance in interacting with the chatbot application; and provide the user with intent-examples using the dynamic user-support capability of the chatbot development platform.

Other embodiments and advantages of the disclosed embodiments are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating a chatbot development system 100 in accordance with an embodiment of the present disclosure.

FIG. 2 is a flowchart illustrating a process 200 for providing dynamic user assistance in a chatbot system in accordance with an embodiment of the present disclosure.

FIG. 3 is a flowchart illustrating a process 300 for selecting the high quality intent-examples in a chatbot system in accordance with an embodiment of the present disclosure.

FIG. 4 is a block diagram illustrating a hardware architecture of a system according to an embodiment of the present disclosure.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to”. Unless otherwise indicated, as used throughout this document, “or” does not require mutual exclusivity, and the singular forms “a”, “an” and “the” are intended to include the plural forms as well, unless the context clearly indicates otherwise.

A module or unit as referenced herein may comprise one or more hardware or electrical components such as electrical circuitry, processors, and memory that may be specially configured to perform a particular function. The memory may be volatile memory or non-volatile memory that stores data such as, but not limited to, computer executable instructions, machine code, and other various forms of data. The module or unit may be configured to use the data to execute one or more instructions to perform one or more tasks. In certain instances, a module may also refer to a particular set of functions, software instructions, or circuitry that is configured to perform a specific task. For example, a module may comprise of software components such as, but not limited to, data access objects, service components, user interface components, application programming interface (API) components; hardware components such as electrical circuitry, processors, and memory; and/or a combination thereof. As referenced herein, computer executable instructions may be in any form including, but not limited to, machine code, assembly code, and high-level programming code written in any programming language.

Also, as used herein, the term “communicates” means capable of sending and/or receiving data over a communication link. The communication link may include both wired and wireless links, and may be a direct link or may comprise of multiple links passing through one or more communication networks or network devices such as, but not limited to, routers, firewalls, servers, and switches. The communication networks may be any type of wired or wireless network. The networks may include private networks and/or public networks such as the Internet. Additionally, in certain embodiments, the term communicates may also encompass internal communication between various components of a system and/or with an external input/output device such as a keyboard or display device.

Chatbots are typically used in dialog systems for various purposes including customer service or information acquisition. Chatbots sometime include a help feature that supports such questions as “what can I say?” or “what kinds of questions can you answer?” However, application developers often build these chatbots in a hurry with limited historical data needed for providing comprehensive and up-to-date user-support information. In addition, even the user-support content and functions are limited because conversation-developers create responses hard-coded to pre-programmed questions, intents, or entities and cannot adapt to changes in the bot, as it evolves (by, for example, addition of new intents or entities, and improvements or addition of new dialog flows) to provide better responses or cover more use cases. Additionally, the current process requires each chatbot developer to implement their own help feature (often times, by using a set of static intents and dialog subflows specifically designed to get help), a process that is tedious and may require specialized expertise.

Accordingly, the disclosed embodiments enable a dynamic help feature for chatbots that is built into a chatbot and its development platform. The dynamic help feature can adapt to changes in user intents because the responses are not hard-coded, but instead dynamically selected and updated based on real-world usage. Additionally, by building a dynamic help feature into a chatbot development platform, chatbot developers may simply incorporate the dynamic help feature of the chatbot development platform into their chatbot applications, thus providing a well-developed dynamic help support feature into their chatbot application without the required experience or cost.

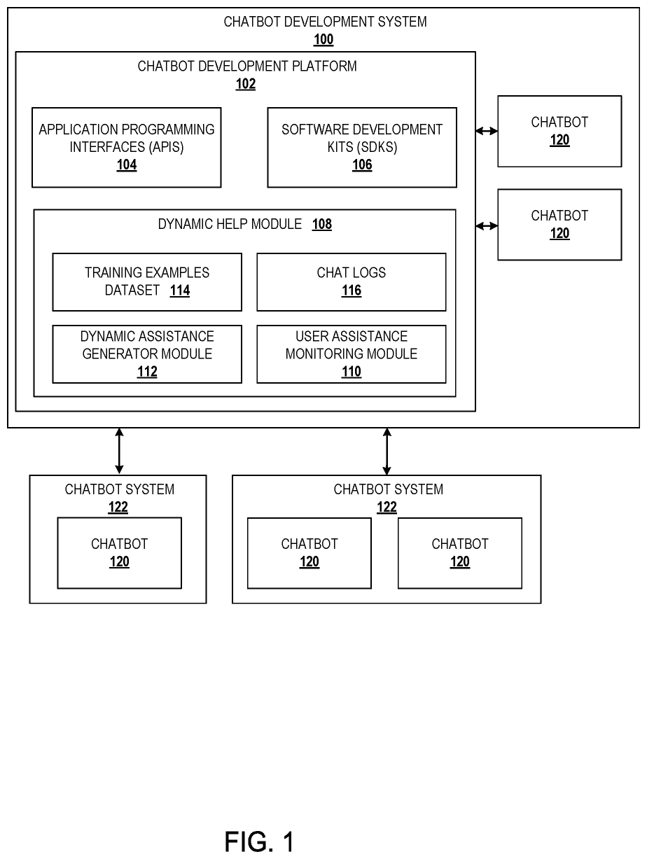

FIG. 1 is a schematic diagram illustrating a chatbot development system 100 in accordance with an embodiment of the present disclosure. In the depicted embodiment, the chatbot development system 100 includes a chatbot development platform 102. The chatbot development platform 102 is an application that provides a base construct for building various chatbots 120. A chatbot 120 is a computer program or an artificial intelligence system that is configured to conduct a conversation via auditory, visual, and/or textual methods. The chatbots 120 may be implemented on one more chatbot systems 122. Additionally, in some embodiments, a chatbot 120 may be implemented on the chatbot development system 100.

The chatbot development platform 102 provides common functionalities that may be used by the developers of the chatbots 120 to ease the task of developing chatbots. For example, the chatbot development platform 102 may include various APIs 104 and software development kits (SDKs) 106 for creating the chatbots 120. An API is an interface that allows software programs to interact with each other. A SDK is a set of tools that can be used to develop software applications targeting a specific platform. A non-limiting example of a chatbot development platform 102 is IBM Watson. Watson's proprietary Conversation Service leverages many artificial intelligent techniques and systems. For example, Watson understands intent, interprets entities and dialogs, supports multiple languages and provides developers with a wide range of SDKs to extend the product.

The chatbots 120 may be used for any purpose. For example, a chatbot 120 may be used on a website to provide users of the website with answers to some basic questions. Another chatbot 120 may be used to assist a user in resetting a password. Still, another chatbot 120 may be used to provide banking services.

In accordance with an embodiment of the present disclosure, the chatbot development platform 102 includes a dynamic help module 108 that may be deployed by the chatbots 120 for providing users of the chatbot 120 with assistance. In some embodiments, because the dynamic help module 108 is built into the chatbot development platform 102 and incorporated into multiple chatbot 120, it may be configured to support certain features across multiple chatbot 120 that would not be available if the help feature was written for a single chatbot application. For example, in certain embodiments, even if a particular chatbot does not support a particular user task requested by a user, the dynamic help module 108 may be able to identify another chatbot application to assist a user. In another instance, when a user says “help’, the dynamic help module 108 may be configured to have all the chatbot 120 introduce themselves and describe their capabilities. In one embodiment, the dynamic help module 108 includes a user assistance monitoring module 110, a dynamic assistance generator module 112, a training examples dataset 114, and chat logs 116.

In one embodiment, the user assistance monitoring module 110 is configured to identify when a user may need assistance in performing one or more functions associated with a chatbot 120. For example, the user assistance monitoring module 110 may be configured to monitor for an explicit request for help by a user. For instance, the user assistance monitoring module 110 may be configured to recognize statements such as, but not limited to, “what can I say,” “what kinds of questions can you answer,” “I need help,” or “ how do I . . . ?” as a request for assistance. The user assistance monitoring module 110 may also be configured to infer that a user may need help. For example, the user assistance monitoring module 110 may be configured to infer that a user may need help if a user repeats or rephrases a request that is not understood by the chatbot 120 more than a predetermined number of times or threshold. For instance, if a user repeats a request more than twice that is not understood by the chatbot 120, the user assistance monitoring module 110 may be configured to identify this scenario as a user in need of assistance.

In response to identifying that a user needs assistance in performing one or more functions associated with a chatbot 120, the dynamic help module 108 may execute the dynamic assistance generator module 112 to provide the user with assistance. In one embodiment, the dynamic assistance generator module 112 is configured to provide the user with one or more intent-examples. Intents are purposes or goals expressed in a customer's input (i.e., keyword that describes what the user is intending to do). For example “changePassword” is an intent. Intent-examples are actual user utterances (things user would say) that are used to train a system for a particular intent. For example, “I would like to get my password updated for my bank account” is an “intent-example” for the intent “changePassword”. An intent has many “intent-examples”. Some are high quality intent-examples; for example, for the “changePassword” intent, “I want to change my online banking password” may be a quality intent-example, whereas “want to chg pwd, can I here?” is not a high quality intent-example (for the purposes of providing user-support for using the chatbot), even though users may have said both to express the same intent, because the first user utterance provides the most useful intent-example for assisting a user with a banking chatbot when provided as an example. By recognizing the intent expressed in a user's input, the chatbot 120 can select the correct dialog flow for responding to it.

In contrast to systems that provide static descriptive-text or intent-examples as help to a user (i.e., the intent-examples are hard coded), the dynamic assistance generator module 112 is configured to determine one or more dynamic intent-examples (which may be in the context of dynamically calculated intents, entities and dialogs). Dynamic intent-examples means that the intent-examples that are presented to assist a user are not hard coded in the chatbot development platform 102 or by a chatbot 120, but instead are selected or determined based on various factors. These factors include, but not limited to, hit-rate of intents, hit rate of entities, intents and entities that were frequently used in high quality conversations in production systems, frames and slots of dialog nodes with intents and entities that hit the previously-listed criteria.

In one embodiment, the dynamic assistance generator module 112 utilizes the intents from the training examples dataset 114. The training examples dataset 114 includes pre-stored training utterances. For instance, examples of pre-stored training utterances for a pay_bill intent may include “I need to pay my bill,” “pay my account balance,” and “make a payment.” In certain embodiments, a developer of a chatbot 120 may add additional intents or training utterances to the training examples dataset 114.

In one embodiment, when a chatbot 120 is new, the dynamic assistance generator module 112 may be configured to rely solely on the intents from the training examples dataset 114. In one embodiment, the top predetermined number of intents may be chosen as the intent-examples based on expected usage frequency, utility to the business, or based on other criteria. In an embodiment, each intent may be marked as having a canonical example. A canonical example is an intent in canonical form (may also be referred to as normalized form or equivalent form) that is intended to capture variations of the intent such as slight differences in phrasing, capitalization, punctuation, plurals, possessives, whitespace, and misspellings.

In various embodiments, once the chatbot 120 is in use, the dynamic assistance generator module 112 may also utilize real intents from the production chat logs 116 to select the dynamic intent-examples to provide to a user. The chat logs 116 may include intents from previous user conversations either by the user or by other users of the chatbot 120. Each logged conversation may include an indication of whether the conversation was successful. For example, success may be indicated through direct user feedback or based on the conversation terminated in a “success’ state such as completing a transaction or other task related to the conversation (e.g., user changes password after asking the chatbot 120 for help in changing password). The dynamic assistance generator module 112 may be configured to harvest intent-examples that are classified as high confidence within the logged conversations. For example, in one embodiment, the conversation logs are examined for the most frequently occurring intents within successful dialogues and these intents are classified as high confidence intents. As more high confidence intents are identified, the dynamic assistance generator module 112 may be configured to replace the training examples in the training examples dataset 114 with the high confidence intents.

In various embodiments, the dynamic assistance generator module 112 may be configured to filter the conversation logs or intents from the conversation logs. For example, in one embodiment, intent-examples are passed through a set of editorial filters to validate or auto-correct spelling, grammar, and completeness. The editorial filters may also filter offensive or inappropriate language, before they are used in dynamically calculated help content.

In some embodiments, the dynamic assistance generator module 112 may be updated periodically while offline using the high confidence intents from the chat logs 116. Alternatively, in some embodiments, the dynamic assistance generator module 112 may be configured to access the chat logs 116 in real-time to identify high confidence intents each time a dynamic intent-example is provided to a user.

Additionally, in some embodiments, the dynamic assistance generator module 112 may be configured to construct additional helpful examples by knowing which entities are commonly used with the intent-examples (e.g., based hit frequency, recent trends, etc.). For example, the “I want to apply” intent-example could be expanded to “I want to apply for a loan” as the most helpful fully-specified sample phrasing, based on popularity of loan entity in the chat logs 116. In some embodiments, instead of using intent-examples alone, the dynamic assistance generator module 112 may be configured to predetermine the required information for certain tasks to embellish the intent-examples with potential entities and dialog-slots (information to be collected), using the same kind of techniques described herein (i.e. hit frequency, trends, recent usage, etc.). For example, the dynamic assistance generator module 112 may execute the “I want to apply for a loan” in a background process to identify the information that a user would need to provide (i.e., often referred to as slots) to apply for a loan. In an embodiment, the dynamic assistance generator module 112 can be configured to provide a summary help text that describes “If you provide me with X, Y, and Z, then I can help you with applying for a loan.” In another example, the dynamic assistance generator module 112 can return: Try telling me “how can I open a checking account.” In addition, the dynamic assistance generator module 112 can determine potential entities to modify the above intent-example to further help the user. For example, the dynamic assistance generator module 112 can state: “You can also ask me the same question with ‘credit card account” because the “openAccount” intent is frequently associated with “credit card” entity. Further, in certain embodiments, the dynamic assistance generator module 112 can further embellish the above intent-example with a dialog slot “customer ID” by saying “Tell me your customer ID, and I can start opening an account” because the “openAccount” intent has a dialog-slot that asks for the user's customer ID (and this is a frequent flow that customers finish a conversation with). The dynamic assistance generator module 112 may also adjust the intent-examples that it provides based on the context or position within the dialogue flow. For instance, using the above loan example, the dynamic assistance generator module 112 would provide a different help response to the user if the loan process is nearly complete in comparison to a help response to the user at the beginning of the loan process.

The dynamic assistance generator module 112 may also be configured to provide a description of an action that is triggered by the intent-examples. For example, if the intent-example is “I want to discuss my investment options,” the dynamic assistance generator module 112 may state that an investment advisor will contact you shortly if the intent-example is initiated by the user. The action triggered by intent-example may be provided as a tooltip that appears when a cursor is positioned over the intent-example or may be generated via existing natural language generation techniques to describe what happens in dialog nodes where that intent is a trigger.

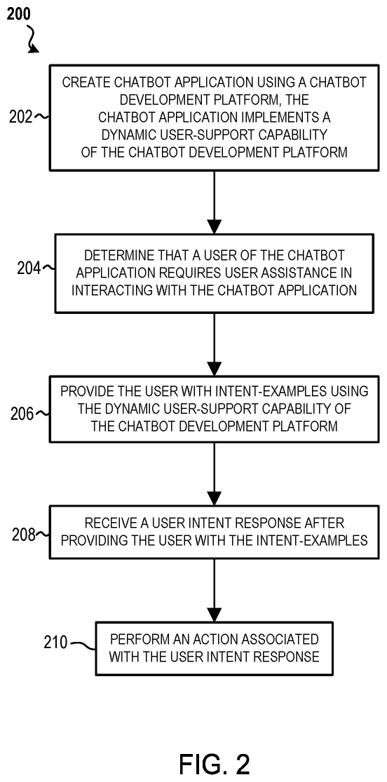

FIG. 2 is a flowchart illustrating a process 200 for providing dynamic user assistance in a chatbot system in accordance with an embodiment of the present disclosure. The process 200 may be implemented by a chatbot system such as, but not limited to, the chatbot development system 100 and chatbot systems 122 of FIG. 1. In the depicted embodiment, the process 200 begins at step 202 by creating a chatbot application using a chatbot development platform. The chatbot application implements a dynamic user-support capability of the chatbot development platform.

The process 200, at step 204, determines that a user of the chatbot application requires user assistance in interacting with the chatbot application. As described above, the process 200 may be configured to monitor for an explicit request by a user for assistance and may also be configured to infer that a user may require assistance such as when a user repeats or rephrases a request multiple times.

At step 206, the process 200 provides the user with intent-examples using the dynamic user-support capability of the chatbot development platform. In one embodiment, to determine the appropriate assistance to provide to a user, the process 200 determines a current position within a conversation workflow. As an example, for a shopping chatbot application, the conversation workflow may be at a beginning of a shopping conversation (e.g., user browsing items), midway through the shopping conversation (e.g., shopping items have been selected), or near the end of the shopping conversation (e.g., at payment collection). The position within a conversation workflow may also be determined using a pre-trained clustering model and/or by analyzing and comparing conversation history to current dialogue.

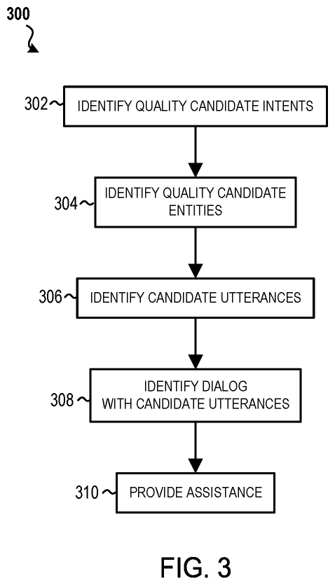

Based on the position of the conversation flow, the process 200 identifies a predetermined number of high quality intent-examples or user utterances for a specific intent from the chatbots' previous conversations. One embodiment for selecting the high quality intent example is described below in FIG. 3. In some embodiments, the predetermined number may be a tunable parameter based on a type of user device. For example, if the user device is a mobile phone, only one or two high quality examples may be displayed. However, if the user device is a desktop client, the process 200 may display a longer list of high quality examples. In some embodiments, the process 200 may also provide a summary/description of the chatbots' action corresponding to an intent-example. For example, the process 200 may display the intent example “deploy the latest build to production” and a corresponding description of the chatbots' action to the intent-example as “Allows deployment of a user-selected component to production environment.”

The process 200, at step 208, receives a user intent response after providing the user with the intent-example. If the provided by the user is recognized, the process 200, at step 210, performs an action associated with the user intent response. The process 200 may also log the user intent response and dialog for updating the dynamic help module of FIG. 1, with the process 200.

FIG. 3 is a flowchart illustrating a process 300 for selecting the high quality intent-examples in a chatbot system in accordance with an embodiment of the present disclosure. The process 300 may be implemented by a chatbot system such as, but not limited to, the chatbot development system 100 and chatbot systems 122 of FIG. 1. In the depicted embodiment, the process 300 begins at step 302 by identifying quality candidate intents. Intents are purposes or goals expressed in a customer's input. In one embodiment, the process 300 may consider several factors in identifying quality candidate intents including, but are not limited to, candidate intents that have a high hit frequency (how often an intent is used), candidate intents that have a high confidence (probability intent is correct for dialog flow), candidate intents that are part of quality conversations (useful conversations that tend to result in success), and candidate intents that have been recently added or used. In certain embodiments, the process 300 may weigh a certain factor higher than others.

At step 304, the process 300 identifies quality candidate entities. An entity is a term or object in the user's input that provides clarification or specific context for a particular intent. As an analogy, if intents represent verbs (something a user wants to do), entities represent nouns (such as the object of, or the context for, an action). A single intent may be associated with multiple entities. As an example, if the chatbot is part of a car dashboard application that enables users to turn accessories on or off, the intent may be “turn on/off” and the entities may be “headlights, radio, air conditioner, etc.” Similar to intents, the process 300 may consider several factors in identifying quality candidate entities including, but are not limited to, entities that aligned with intents, high frequency/confidence entities, and entities that are part of quality conversations.

At step 306, the process 300 identifies candidate utterances based on the identified quality candidate intents and entities. In one embodiment, if session logs containing user requested intent exists, the process 300 attempts to identify candidate utterances that contain the identified quality candidate intents and entities in the session logs. If there are no session logs, the process 300 attempts to identify candidate utterances in a training example dataset. In one embodiment, the process 300 ranks the candidate utterances. For example, the process 300 may rank the candidate utterances by conversation, grammatical quality, entity frequency, and various other factors.

At step 308, the process 300 identifies dialog containing with candidate utterances. In one embodiment, the process 300 determines if the matching dialog includes frame nodes or content nodes. Frame nodes are nodes or questions that require additional user information. As an example, a hotel reservation dialog may include frame nodes that require additional information from a user such as check-in/checkout dates and number of guests. Content nodes are questions that can be answered without requiring any additional information (e.g., what is the minimum age to obtain a driver's license in Texas?).

At step 310, the process 300 provides the dynamic help to the user. In one embodiment, the process 300 displays utterances and their intent-summary (i.e., an explanation of what the intent is used for) as examples. In some embodiments, the process 300 may pre-fetch answers to content nodes and/or may request the additional information from a user to satisfy a frame node. For example, the process 300 may state to a user: You can say make a hotel reservation for [July 4th] to [July 10^{th}] for [2] guests. In certain embodiments, the process 300 may also display entities that match the intents. For example, if the chatbot is part of a car dashboard application, the process 300 may display you can say “turn on/off [headlights], [radio], [air conditioner], [seat warmer], and [navigation].”

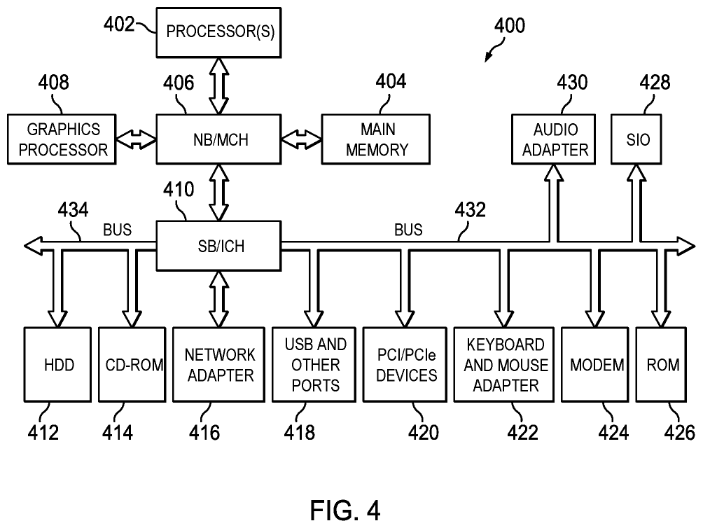

FIG. 4 is a block diagram illustrating a hardware architecture of a data processing system 400 according to an embodiment of the present disclosure in which aspects of the illustrative embodiments may be implemented. For example, in one embodiment, the chatbot development platform 102 of FIG. 1 may be implemented using the data processing system 400. Additionally, the data processing system 400 may be configured to store and execute instructions for performing the process described in FIG. 4. In the depicted example, the data processing system 400 employs a hub architecture including north bridge and memory controller hub (NB/MCH) 406 and south bridge and input/output (I/O) controller hub (SB/ICH) 410. Processor(s) 402, main memory 404, and graphics processor 408 are connected to NB/MCH 406. Graphics processor 408 may be connected to NB/MCH 406 through an accelerated graphics port (AGP). A computer bus, such as bus 432 or bus 434, may be implemented using any type of communication fabric or architecture that provides for a transfer of data between different components or devices attached to the fabric or architecture.

In the depicted example, network adapter 416 connects to SB/ICH 410. Audio adapter 430, keyboard and mouse adapter 422, modem 424, read-only memory (ROM) 426, hard disk drive (HDD) 412, compact disk read-only memory (CD-ROM) drive 414, universal serial bus (USB) ports and other communication ports 418, and peripheral component interconnect/peripheral component interconnect express (PCI/PCIe) devices 420 connect to SB/ICH 410 through bus 432 and bus 434. PCI/PCIe devices 420 may include, for example, Ethernet adapters, add-in cards, and personal computing (PC) cards for notebook computers. PCI uses a card bus controller, while PCIe does not. ROM 426 may be, for example, a flash basic input/output system (BIOS). Modem 424 or network adapter 416 may be used to transmit and receive data over a network.

HDD 412 and CD-ROM drive 414 connect to SB/ICH 410 through bus 434. HDD 412 and CD-ROM drive 414 may use, for example, an integrated drive electronics (IDE) or serial advanced technology attachment (SATA) interface. In some embodiments, HDD 412 may be replaced by other forms of data storage devices including, but not limited to, solid-state drives (SSDs). A super I/O (SIO) device 428 may be connected to SB/ICH 410. SIO device 428 may be a chip on the motherboard that is configured to assist in performing less demanding controller functions for the SB/ICH 410 such as controlling a printer port, controlling a fan, and/or controlling the small light emitting diodes (LEDS) of the data processing system 400.

The data processing system 400 may include a single processor 402 or may include a plurality of processors 402. Additionally, processor(s) 402 may have multiple cores. For example, in one embodiment, data processing system 400 may employ a large number of processors 402 that include hundreds or thousands of processor cores. In some embodiments, the processors 402 may be configured to perform a set of coordinated computations in parallel.

An operating system is executed on the data processing system 400 using the processor(s) 402. The operating system coordinates and provides control of various components within the data processing system 400 in FIG. 4. Various applications and services may run in conjunction with the operating system. Instructions for the operating system, applications, and other data are located on storage devices, such as one or more HDD 412, and may be loaded into main memory 404 for execution by processor(s) 402. In some embodiments, additional instructions or data may be stored on one or more external devices. The processes described herein for the illustrative embodiments may be performed by processor(s) 402 using computer usable program code, which may be located in a memory such as, for example, main memory 404, ROM 426, or in one or more peripheral devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for providing dynamic help in a chatbot application, the computer-implemented method comprising:
determining that a user of the chatbot application requires help in interacting with the chatbot application using a dynamic chatbot help feature of a chatbot development platform implemented in the chatbot application, the dynamic chatbot help feature of the chatbot development platform eliminating a need of a developer of the chatbot application to develop their own chatbot help feature for the chatbot application;
providing the user with intent-examples that inform the user of capabilities of the chatbot application using the dynamic chatbot help feature of the chatbot development platform;
receiving a user intent response after providing the user with the intent-examples; and
performing an action associated with the user intent response.

2. The computer-implemented method of claim 1, further comprising providing a description of an action that is triggered by the intent-examples.

3. The computer-implemented method of claim 1, further comprising:
recording the user intent response in a chat log for updating the dynamic chatbot help feature of the chatbot development platform; and
updating the dynamic chatbot help feature of the chatbot development platform using the chat log.

4. (canceled)

5. The computer-implemented method of claim 1, wherein providing the user with intent-examples using the dynamic chatbot help feature of the chatbot development platform comprises:
determining candidate intents and candidate entities based on a plurality of factors;
identifying candidate utterances based on the candidate intents and candidate entities; and
identifying dialog that includes the candidate utterances.

6. The computer-implemented method of claim 5, wherein the plurality of factors comprises high hit frequency, high confidence, quality of conversations, and recent usage.

7. The computer-implemented method of claim 5, wherein identifying the candidate utterances based on the candidate intents and candidate entities comprises matching real utterances in user logs to the candidate utterances.

8. The computer-implemented method of claim 5, wherein identifying dialog that includes the candidate utterances comprises determining if a matching dialog includes frame nodes.

9. The computer-implemented method of claim 1, wherein providing the user with intent-examples using the dynamic chatbot help feature of the chatbot development platform comprises providing an intent-summary corresponding to the intent-examples.

10. The computer-implemented method of claim 1, wherein determining that the user of the chatbot application requires help in interacting with the chatbot application comprises identifying an explicit user help request.

11. The computer-implemented method of claim 1, wherein determining that the user of the chatbot application requires help in interacting with the chatbot application comprises identifying that the user has repeated a request exceeding a predetermined threshold.

12. The computer-implemented method of claim 1, further comprising applying editorial filters prior to providing the user with the intent-examples.

13. A system configured to provide dynamic help support in a chatbot application, the system comprising memory for storing instructions, and a processor configured to execute the instructions to:
determine that a user of the chatbot application requires help in interacting with the chatbot application using a dynamic chatbot help feature of a chatbot development platform implemented in the chatbot application, the dynamic chatbot help feature of the chatbot development platform eliminating a need of a developer of the chatbot application to develop their own chatbot help feature for the chatbot application; and
provide the user with intent-examples that inform the user of capabilities of the chatbot application using the dynamic chatbot help feature of the chatbot development platform.

14. The system of claim 13, wherein providing the user with the intent-examples using the dynamic chatbot help feature of the chatbot development platform comprises:
determining candidate intents and candidate entities based on a plurality of factors;
identifying candidate utterances based on the candidate intents and candidate entities; and
identifying dialog that includes the candidate utterances.

15. The system of claim 13, wherein providing the user with the intent-examples using the dynamic chatbot help feature of the chatbot development platform comprises providing an intent-summary corresponding to the intent-examples.

16. The system of claim 13, wherein the processor is configured to further execute the instructions to apply editorial filters prior to providing the user with the intent-examples.

17-20. (canceled)

21. A development platform comprising a preconfigured dynamic chatbot help module that may be added to a chatbot application, the dynamic chatbot help module providing a help feature configured to:
determine that a user of a chatbot application requires help in interacting with the chatbot application; and
provide the user with intent-examples that inform the user of capabilities of the chatbot application, wherein the chatbot development platform eliminates a need for a chatbot application developer to develop a chatbot help feature for the chatbot application.

22. The development platform of claim 21, wherein in providing the user with intent-examples that inform the user of capabilities of the chatbot application, the dynamic chatbot help module is further configured to provide an intent-summary corresponding to the intent-examples.

23. The development platform of claim 21, wherein in providing the user with intent-examples that inform the user of capabilities of the chatbot application, the dynamic chatbot help module is further configured to:
determine candidate intents and candidate entities based on a plurality of factors;
identify candidate utterances based on the candidate intents and candidate entities; and
identify dialog that includes the candidate utterances.

24. The development platform of claim 23, wherein the plurality of factors comprises high hit frequency, high confidence, quality of conversations, and recent usage.
